(19) United States
(12) Patent Application Publication
(10) Pub. No.: US 2015/0329235 A1
(43) Pub. Date: Nov. 19, 2015

(54) SHELF READY PACKAGING HAVING STRUCTURAL INTEGRITY, AND PROCESSES FOR MAKING THEM

(71) Applicant: The Procter & Gamble Company, Cincinnati, OH (US)

(72) Inventors: Constantino ARMIENTO, Brussels (BE); Luc Victoire Aloys-Albert CATTHOOR, Temse (BE); Gang HUANG, Vilvoorde (BE)

(21) Appl. No.: 14/711,022

(22) Filed: May 13, 2015

(30) Foreign Application Priority Data
May 13, 2014 (EP) 14168072.8

(51) Int. Cl. B65D 5/02; B31B 1/74; B65D 5/16; B65D 5/72; B65D 19/38; B65D 5/00

(52) U.S. Cl. CPC B65D 5/0236; B65D 19/38; B65D 5/001; B65D 5/16; B65D 5/725; B31B 1/74

(57) ABSTRACT

A shelf ready package, and method of manufacturing a shelf ready package, which is at least partially sealed using tape which overlaps with at least part of a line of weakness in the outer case, the tape having perforations which coincide with at least part of the line of weakness of the outer case.

### FIELD OF THE INVENTION

Stackable outer case packaging for transporting and displaying articles contained therein.

### BACKGROUND OF THE INVENTION

Outer cases, such as cartons, made from cardboard, paperboard, or similar materials are well known and used for transporting and storing various types of articles, including retail articles and the like. Shelf ready packaging are a means for packaging a plurality of articles in outer cases in a manner that they can be displayed, for instance on a supermarket shelf or aisle, directly from the outer case without first having to remove the articles from the outer case. The individual articles, contained within the shelf ready packaging, can be individual packets, cans, bottles, bags, boxes, and the like. Typically, the shelf ready packaging has a removable element, formed by a line of weakness in the outer-case, which can be easily removed. Once the removable element has been removed, the articles contained within are displayed to the customer, and the customer is able to remove the displayed article.

Shelf ready packages are typically made from carton blanks, in which lines of weakness are added via perforations or mechanical scoring. The carton blank is shaped and typically glued to form the four walls. The bottom flaps are then folded together and either taped or glued to form the bottom of the shelf ready package, before the articles are placed inside the shelf ready package. The top flaps are then folded together and either glued or taped together. When glued, the lower flaps have to be supported, for instance by the articles contained within the shelf ready package, or by flaps which fit into slots on the top edge of the outer case side walls, in order for there to be sufficient contact between the flaps which form the top of the outer case, to result in a strong glued bond. Thus, when the top flaps are glued together, the articles contained within the shelf ready package must fill the full height of the package, or else another means of supporting the inner flaps must be provided. As a result, when the packages are stacked on top of each other, the weight of the higher shelf ready packages must be at least partially supported by the articles contained within the lower shelf ready packages. This is less than ideal for articles which are fragile, and can be damaged by the weight of the cartons placed on top of the carton which contain the articles.

Alternatively, the outer flaps of the carton blank can be folded together and taped shut. Tape is preferred, since taping avoids the need to support the inner flaps, and results in a dust tight seal of the top of the outer case. However, such shelf ready packaging have a limited opening size, especially on the top face, since the removable element cannot overlap the top middle seam which has been taped. Where the removable element overlaps the tape, used to seal the top of the outer case, a knife or similar tool is required to remove the removable element.

Shelf ready packaging avoids the time consuming effort associated with removing article from the outer case and placing on shelves. Store owners are constantly looking for additional ways in which to reduce costs for stacking articles, while ensuring that the article remains presentable to the potential customer. One solution is to stack such shelf ready packaging on top of other shelf ready packaging. However, the lines of weakness in the shelf ready packaging result in a structurally weaker outer case, which can collapse or deform under the weight of the outer cases placed on top of it. This is particularly the case when the removable element is large, covers more than one face of the outer case, or is not symmetrically positions on the shelf ready package, and especially when the line of weakness transverses a vertical corner of the case.

Hence, a need remains for a shelf ready package with sufficient structural integrity that they can be stacked on top of each other, especially when the removable element is positioned asymmetrically on the outer case, and when the removable element is large in order to provide greater viewing and accessibility of article contained within, and can be removed without a tool.

### SUMMARY OF THE INVENTION

The present invention relates to a shelf ready package comprising at least one carton blank, formed into an outer case having: a top wall, two side walls, a front wall, a back wall; the shelf ready package further comprising an at least partially removable element, formed by a line of weakness, such that the at least partially removable element can be at least partially or fully removed along the line of weakness. The shelf ready package is at least partially sealed using tape which overlaps with at least part of the line of weakness in the outer case, and the tape comprises tape perforations which coincide with at least part of the line of weakness of the outer case formed by the carton blank.

The present invention further relates to pallets comprising a plurality of shelf ready packages, and processes for making such shelf ready packages.

### BRIEF DESCRIPTION OF THE DRAWINGS

FIG. 1 is a perspective view of a shelf ready package (1) with the top wall (6) held together with tape (20). An at least partially removable element (30) is formed by a line of weakness (40) in the outer case. The tape (20) comprises tape perforations (50) where it coincides the line of weakness (40) which forms the at least partially removable element (30).

FIG. 1a shows an enlarged view of the shelf ready package of FIG. 1, comprising a line of weakness (40) in the outer case, and tape (20) having tape perforations (50) formed by perforation components (41) and landed components (42), the tape perforations (50) partially coinciding with the line of weakness (40).

FIG. 2 is a perspective view of a shelf ready package (1), comprising a tray (2) and hood (3). The hood (3) comprises a top wall (6) held together with tape (20). An at least partially removable element (30) is formed by a line of weakness (40) in the hood (3). The tape (20) comprises tape perforations (50) where it coincides the line of weakness (40) which forms the at least partially removable element (30).

FIG. 3 is a perspective view of a shelf ready package (1) with the top wall (6) held together with tape (20). An at least partially removable element (30) is formed by a line of weakness (40) in the outer case. The tape (20) is perforated such that the tape perforations (50) repeatedly cross line of weakness (40). The shelf ready package (1) further comprises a grasping member (38), formed by a secondary line of weakness (39).

FIG. 4a is a view of a carton blank (60), which can be used to make a shelf ready package of the present invention. After the carton blank has been formed and filled, a line of weakness is applied, in addition to tape to seal the formed shelf ready package.

FIG. 4b is a view of a carton blank (60), which comprises a line of weakness (40), for forming a shelf ready package as shown in FIG. 6 or 7.

FIG. 4c is a view of a carton blank (60), which comprises a line of weakness (40), for forming a shelf ready package wherein the at least partially removable element (30) fully overlaps the tape (20).

FIG. 4d is a view of a carton blank (60), which comprises a line of weakness (40) and a fold line (43), for forming a shelf ready package as shown in FIG. 8.

FIG. 5 is a perspective view of a shelf ready package (1) with the top wall (6) held together with tape (20). An at least partially removable element (30) is formed by a line of weakness (40) in the outer case. The tape (20) is perforated such that the tape perforations (50) repeatedly cross line of weakness (40) on the top wall (6). The shelf ready package (1) further comprises grasping members (38), formed by a secondary line of weakness (39).

FIG. 6 is perspective view of a the shelf ready package (1) of FIG. 1, wherein the tape perforations (50) coincide with the line of weakness (40) along the top face (6) and part of the side face (3), in which the at least partially removable element (30) has been removed.

FIG. 7 is perspective view of the shelf ready package (1) of FIG. 3, wherein the tape (20) is perforated such that the tape perforations (50) repeatedly cross the line of weakness (40). The at least partially removable element (30) has been fully removed.

FIG. 8 is perspective view of a shelf ready package (1), formed from the carton blank of FIG. 4d. The at least partially removable element (30) has been partially removed, and folded at the fold line (43), to display advertising printed on the inner surface of the at least partially removable element (30).

FIG. 9 is a perspective view of a shelf ready package (1) with the top wall (6) held together with tape (20). An at least partially removable element (30) is formed by a line of weakness (40) in the outer case. The tape (20) comprises tape perforations (50) where it coincides the line of weakness (40) which forms the at least partially removable element (30). A display panel (80) is attached to the front wall (2), and side walls (3) and (4), such that the display panel (80) covers the vertical corner through which the line of weakness (40) passes.

FIG. 10 is perspective view of a shelf ready package (1) of FIG. 9, in which the at least partially removable element (30) has been removed.

### DETAILED DESCRIPTION OF THE INVENTION

A shelf ready package with sufficient structural integrity that they can be stacked on top of each other, even when the at least partially removable element is positioned asymmetrically on the outer case, can be achieved by sealing the shelf ready package with tape, such that the tape perforations (50) at least partially coincide with the perforations which form part of the line of weakness in the outer case. The non-perforated part of the tape reinforces the line of weakness such that it does not fail under the weight of stacked cases, even when the line of weakness passed through a vertical corner, and even when the at least partially removable element, formed by the line of weakness, is large such that the line of weakness passes through a significant proportion of the outer case.

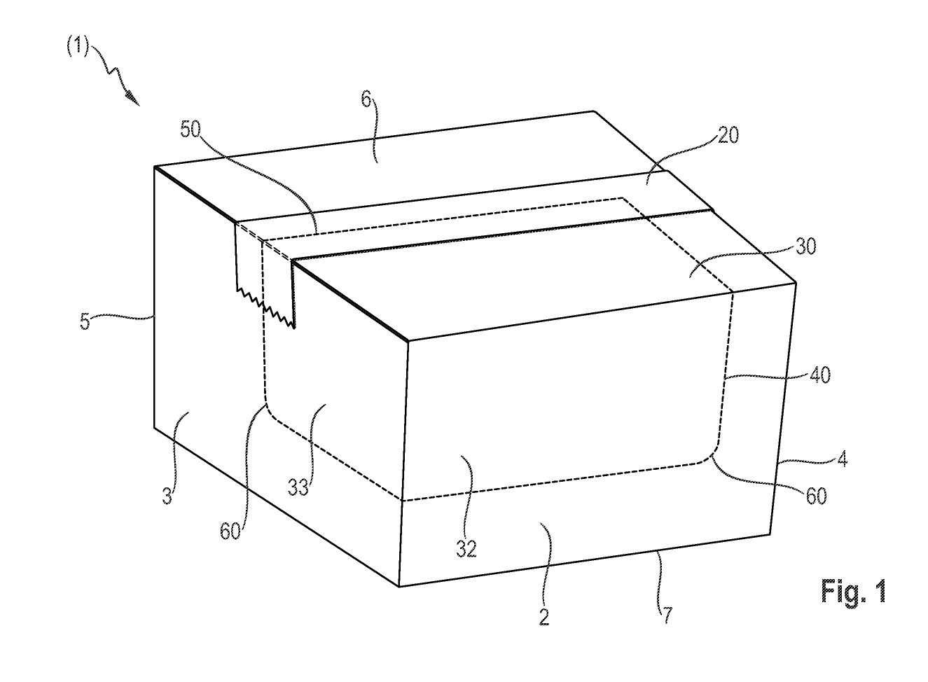

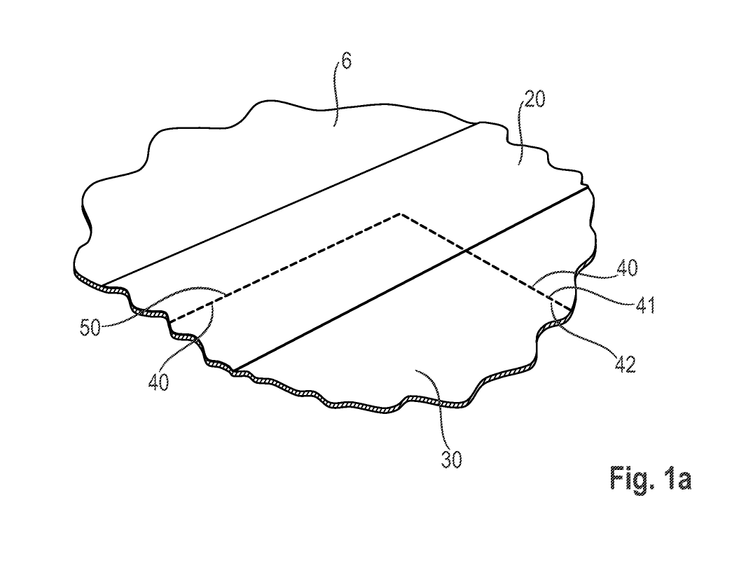

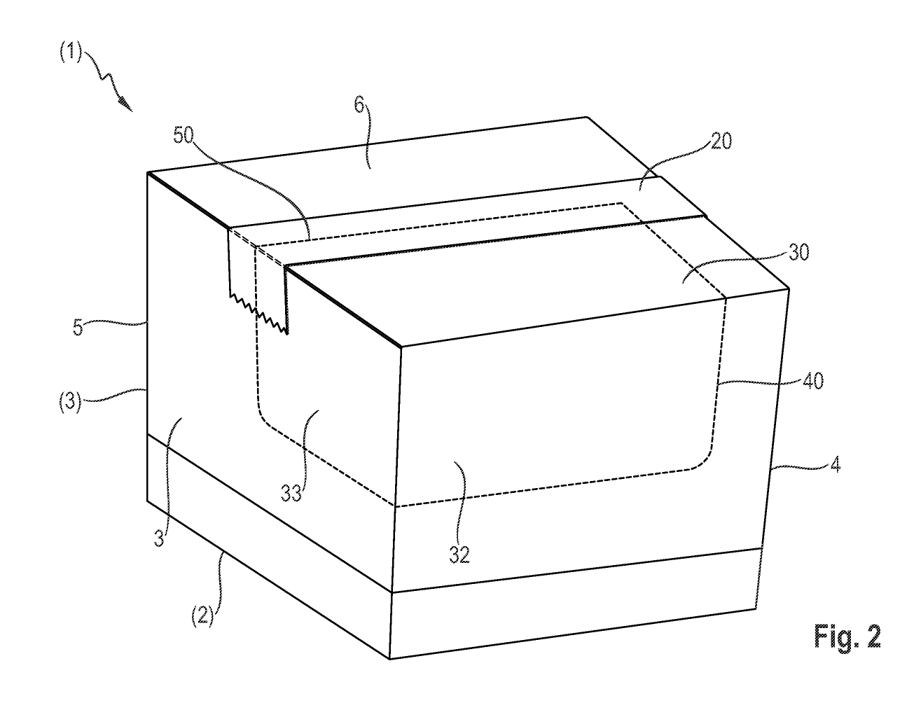

A shelf ready package (1) of the present invention is shown in FIGS. 1 and 2, having a front wall (2), side walls (3) and (4), a back wall (5), and a top wall (6). A bottom wall (7) completes the container, for totally enclosing and protecting articles contained therein.

Any suitable article can be contained within the shelf ready package, including: fabric care products such as liquid laundry bottles, powdered laundry bags, fabric softeners, and the like; household cleaners, including dish washing agents, floor cleaners, and the like; personal care products such as moisturisers, cosmetics, shampoos, shaving products, and the like; diaper bags; perfumes; pet food; and combinations thereof.

Such shelf ready packages can be delivered to retail outlets, and the like, on a pallet comprising at least two layers of the shelf ready package (1). More preferably, such pallets comprise at least 3, more preferably at least 4 layers of shelf ready packages (1). The maximum number of layers of shelf ready packages (1) is typically 8, more typically 6, for instance, due to the size of delivery trucks.

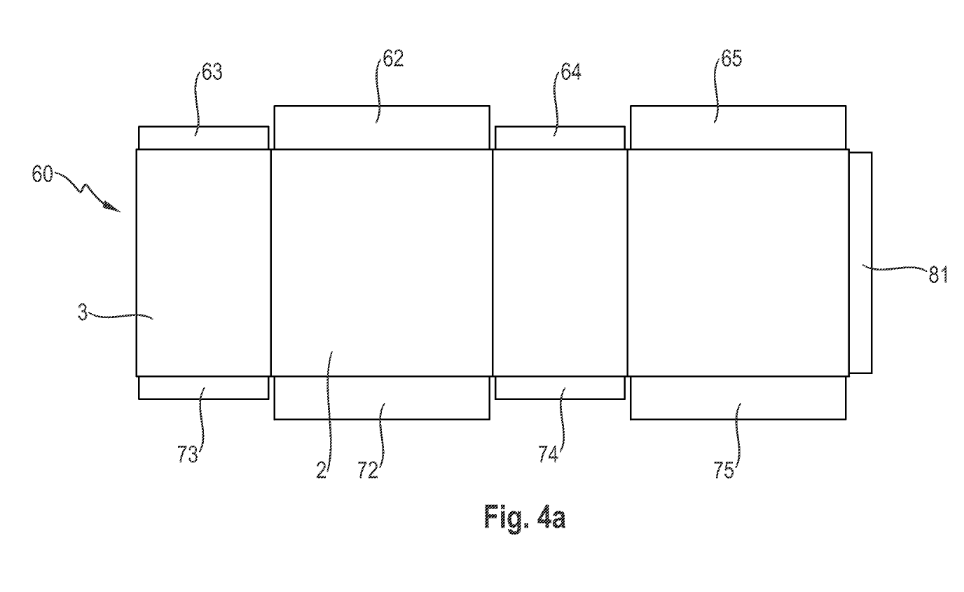

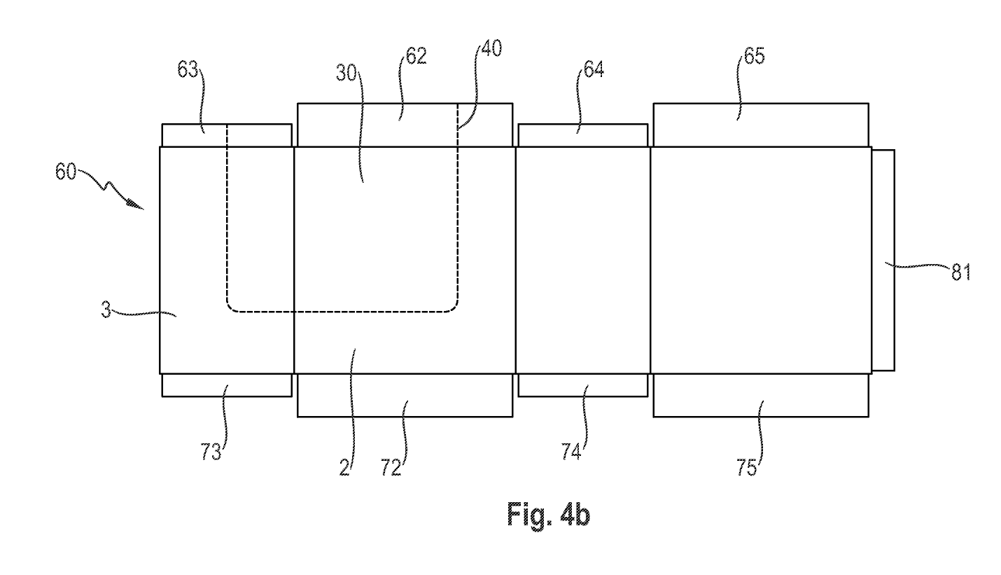

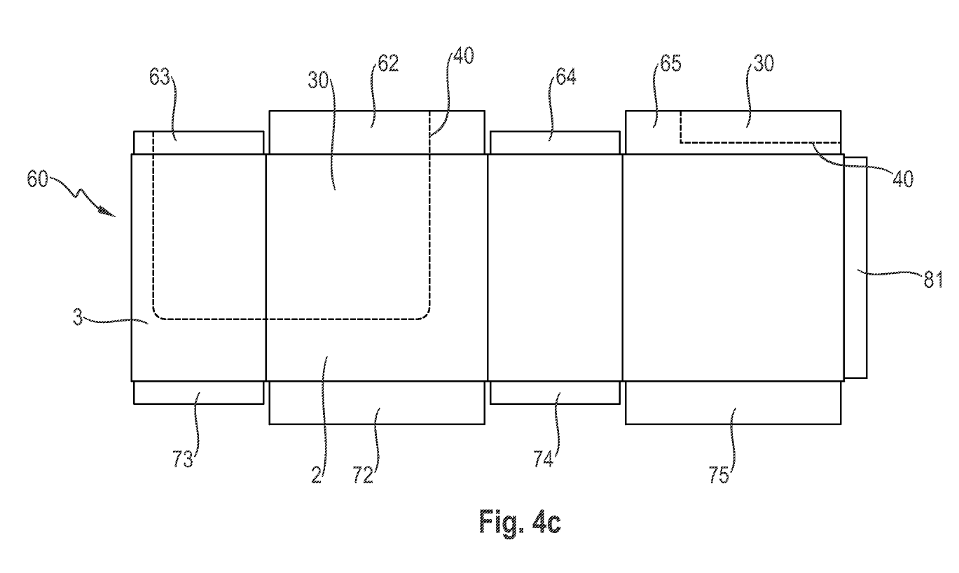

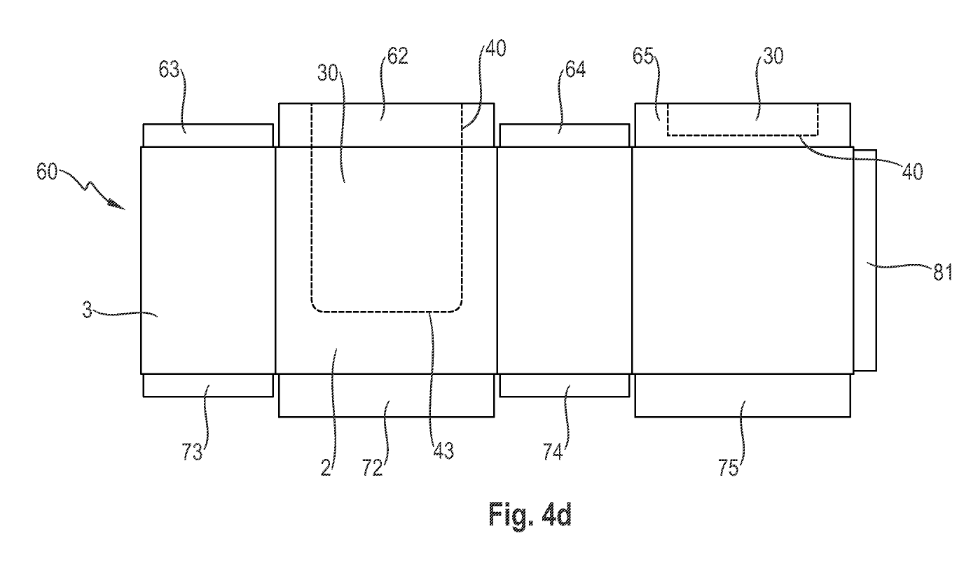

The shelf ready package (1) is formed from at least one carton blank (60). The carton blank (60) can be made from any suitable material, such as paperboard, plastic, and combinations thereof. The carton blank (60) can be corrugated or non-corrugated. Each of the front wall (2), two side walls (3) and (4), and back wall (5) contain upper portions (61), (62), (63) and (64) respectively (see FIGS. 4a to 4d). The upper portions (61), (62), (63) and (64) collectively form the top wall (6). The carton blank (60) can also include a attachment seam (81), in order to connect together the left-most part and right-most part of the carton blank (60), for instance, by glueing.

The shelf ready package (1) can comprise an outer-case having a bottom wall (7), typically made from one carton blank (60) (see FIG. 1a). Such carton blanks typically comprise lower portions (71), (72), (73) and (74) respectively, which form the bottom wall (7). The lower portions (71), (72), (73) and (74) are preferably formed into the bottom wall (7) using adhesive tape, gluing, and combinations thereof, though gluing is preferred.

Alternatively, the shelf ready package (1) can be a tray (2) and hood (3) combination (see FIG. 2), made from at least 2 carton blanks (see FIG. 1b). For shelf ready packages (1) which comprise a tray (2) and hood (3), the carton blank (60) is formed into the hood (3), which fits into the tray (2). Such hoods (3) do not comprise a bottom wall (7). In order to improve structural rigidity, particularly during transport and handling, the overlapping parts of the tray (2) and hood (3) can be glued together.

The shelf ready package (1) comprises a line of weakness (40), and an at least partially removable element (30). The at least partially removable element is at least partially removed by separating the at least partially removable element (30) from the outer case, along the line of weakness (40).

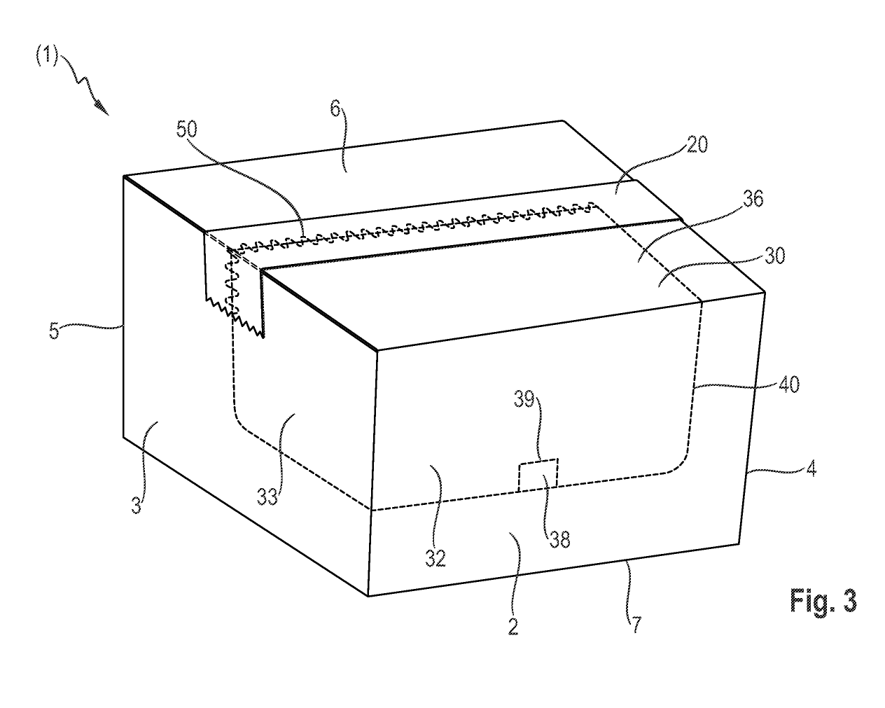

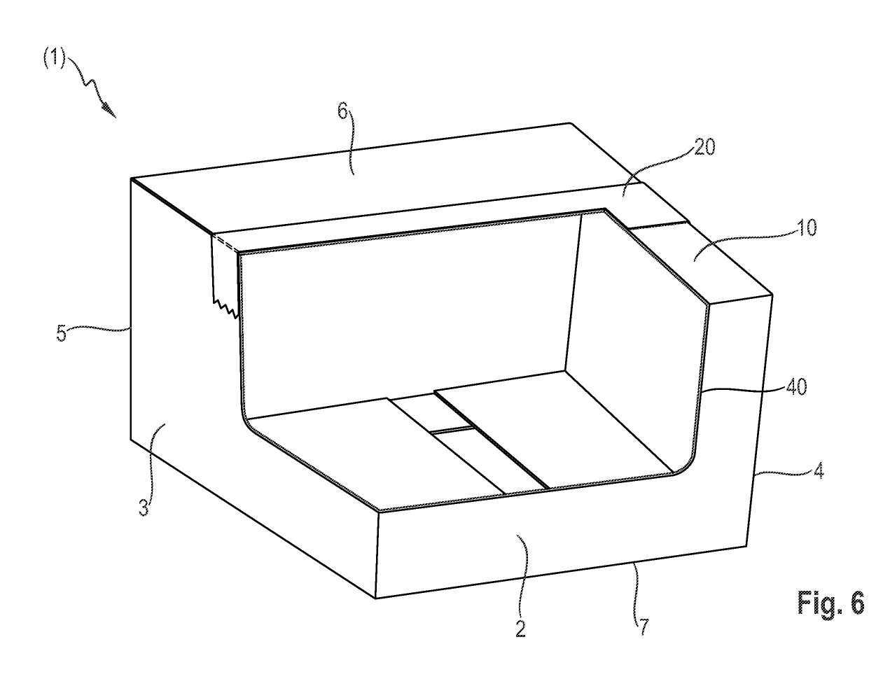

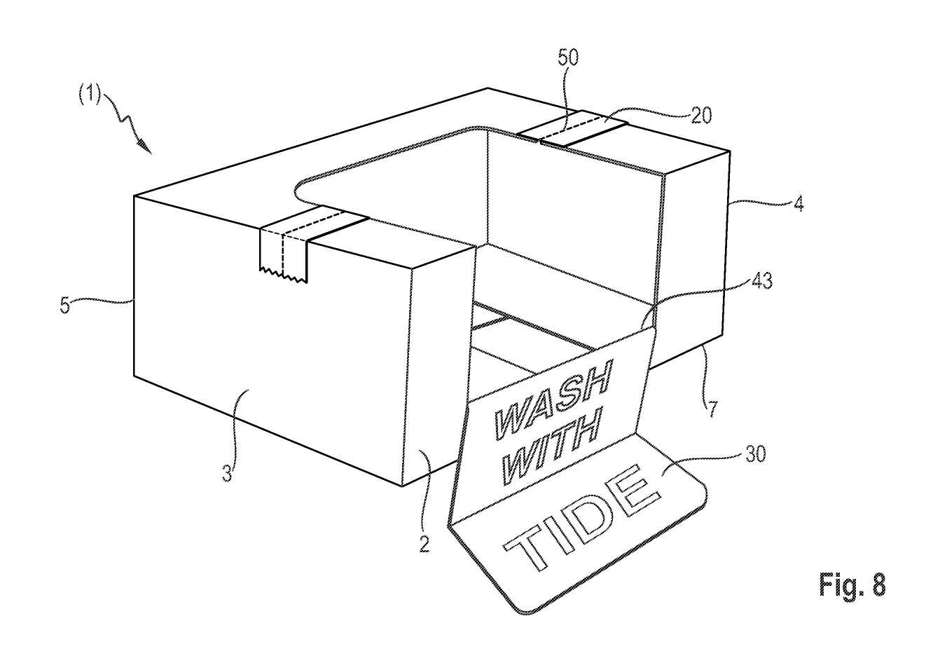

The line of weakness (40) is preferably continuous, such as forming a loop, so that the at least partially removable element (30) can be fully removed (see FIG. 6), preferably by hand, more preferably without the use of a tool. However, the line of weakness can also be discontinuous, such that the at least partially removable element (30) remains partly attached. For instance, when the interior surface of the removable element comprises graphics, advertising, usage instructions, and combinations thereof (see FIG. 6). When it is desirable that the at least partially removable element (30) remains partially attached to the shelf ready package, the shelf ready package (1) typically comprises a fold line (43) (see FIG. 8). Such fold lines can be added to the carton blank (60) (see FIG. 3d), or can be added after the carton has been assembled into an outer case. In the latter case, the fold line can be formed by any suitable means, such as scoring, perforating, and combinations thereof.

Scoring can be achieved by applying suitable pressure onto a knife or sharp element which is placed on the carton blank (60), before or after forming the carton blank into an outer case. A perforated fold line (43) can be formed using any suitable means, such as punch pins (typically in the form of dots or slits), a cutting disc, or a laser. For carton blanks which comprise paperboard, lasers are not preferred.

The fold line (43) preferably has a resistance to separation which is higher than that of the line of weakness (40).

FIG. 1a is an enlarged view of area of FIG. 1, illustrating a preferred embodiment of the continuous line of weakness (40) comprising perforation components (41) and land components (42). The dimensions of the perforation components (41) and land components (42) are defined to ensure protection of the articles prior to removing the at least partially removable element (30), while allowing easy and clean opening of the shelf ready packaging (1). The perforation components (41) of the continuous line of weakness (40) are preferably 1.5 to 25 millimeters in length, more preferably 10 to 15 millimeters in length. The perforation component (41) preferably is comprised of a hole or slit which penetrates the full thickness of the material forming the carton blank (60). The perforation components (41) and land components (42) can be oriented along the line of weakness (40). Alternatively, and in order to increase the force required to remove part or all of the removable element (30), part or all of the perforation components (41) can be oriented at an angle from the direction of the line of weakness (40). Alternatively, or in addition, if a stronger line of weakness (40) is desired, the perforation can penetrate part way through the thickness of the material forming the carton blank. Alternatively, a stronger line of weakness (40) can be provided by reducing the length of the perforation components (41), and correspondingly increasing the length of the land components (42). The land components (42) of the continuous line of weakness (40) are preferably from 1.5 to 4 millimeters in length, more preferably from 2.5 millimeters to 3.5 millimeters in length.

In addition, the continuous line of weakness (40) preferably has a minimum radius at points of directional change of at least 10 millimeters. Points of directional change, as used herein, do not include the corners of the container. The minimum radius aids in the ease and clean removal of the at least partially removable element (30) from the shelf ready packaging (1). The radius at points of directional change is preferably 20 to 50 millimeters. FIG. 1 depicts points of directional change (60) of the continuous line of weakness 40.

The vertical position of the continuous line of weakness (40) on the front wall (2), back wall (5), and side walls (3) and (4), is set to provide proper retention of contained articles and an unobstructed view of, and access to, articles housed by the shelf ready package (1).

The at least partially removable element (30) can be present on the front wall (2), side walls (3) and (4), top wall (6), and combinations thereof. The at least partially removable element (30) preferably comprises a front face (32), more preferably the at least partially removable element (30) comprises a front face (32) and top face (36). Even more preferably, the at least partially removable element (30) comprises a front face (32), top face (36), and at least one side face (33) or (34). In the most preferred embodiment, the at least partially removable element (30) consists of a front face (32), top face (36), and one side face (33) or (34). Such embodiments provide a large opening to view and remove articles contained within the shelf ready packaging (1), once the at least partially removable element (30) has been removed, while also providing a corner, side wall (3) or (4), and back wall (5) to support other shelf ready packages that may have been placed on top of the shelf ready package.

If present, the front face (32) of the at least partially removable element (30) preferably comprises from 25 to 95 percent of the front wall (2) area, more preferably from 50 to about 90 percent of the front wall (2) area. If present, the top face (36) of the at least partially removable element (30) preferably comprises from 25 to 85 percent of the top wall (6) area, more preferably from 40 to about 70 percent of the top wall (6) area. Where the at least partially removable element (30) is not fully removable, the wall area of the shelf ready package (1) which forms the at least partially removable element (30) is calculated based on the shortest straight line between the start of the line of weakness (40) and end of the line of weakness (40).

The line of weakness (40) can be made using any known means, such as scoring; perforating; and combinations thereof. The line of weakness (40) can be a single line, or a series of lines, such as those that make up a tear strip configuration. Preferably, the line of weakness (40), is a perforated line as illustrated in the Figures. The line of weakness can be formed either on the carton blank (60), before assembly of the outer case, or on the assembled outer case, after it has been filled with the desired articles. Scoring can be achieved by applying suitable pressure onto a knife or sharp element which is placed on the carton blank or formed carton. A perforated line of weakness can be formed using any suitable means, such as punch pins (typically in the form of dots or slits), a cutting disc, or a laser.

The line of weakness (40) has a substantially constant resistance to separation along its length. For example, if the line of weakness (40) is a scored line, then it is of constant depth and density. Alternatively, if the line of weakness (40) is a perforated line, the dimensions of the perforation and the un-perforated portion in-between the perforations is constant. The properties of the line of weakness (40) may vary in the corners of the outer case to impart strength properties as described more fully below.

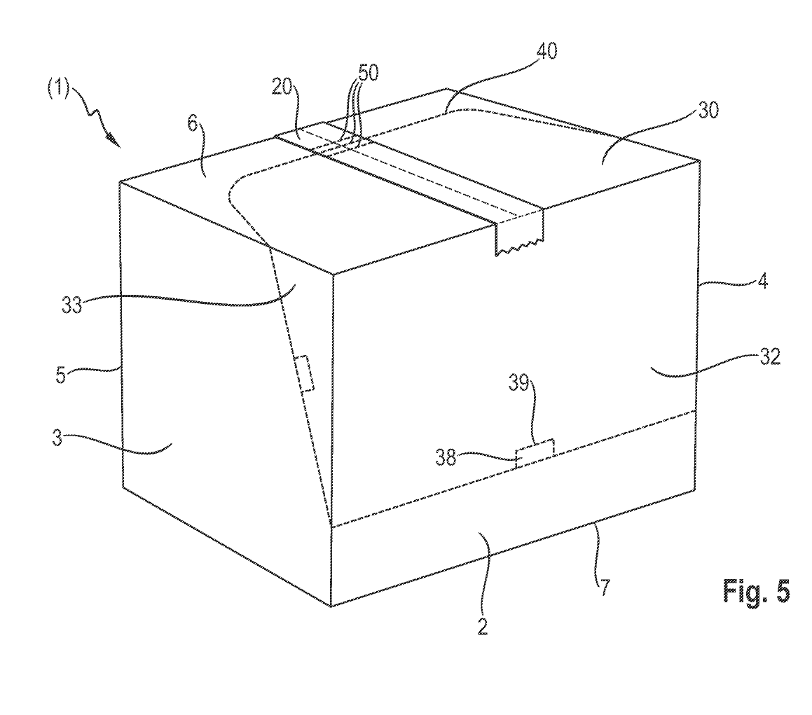

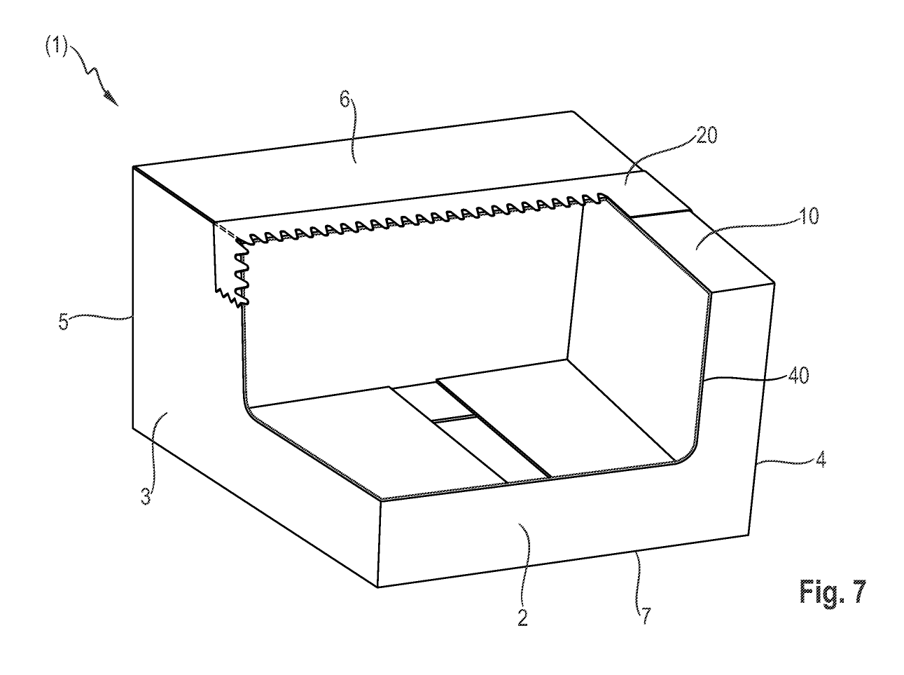

The shelf ready package is at least partially sealed using tape (20) which overlaps at least part of the line of weakness (40). The tape is perforated, such that the tape perforations (50) coincide with at least part of the line of weakness (40). The tape perforations (50) can overlap across a length of the line of weakness (as in FIG. 1), or alternatively, can criss-cross over the line of weakness (as in FIG. 3, FIG. 5, and FIG. 7). Preferably, the tape (20) connects the first upper portion (62) and the second upper portion (65). In preferred embodiments, the line of weakness (40) is at least partially present on an upper portion selected from the group consisting of: the first upper portion (62), the second upper portion (65), or combinations thereof; and partially coincides with the tape perforations (50) on the tape (20) which connects the first upper portion (62) and the second upper portion (65).

The tape perforations (50) can be formed after the tape has been applied to the outer case, formed by the carton blank (60), in order to minimise tape breakage during tape application, and allow more precise alignment of the tape perforations (50) with the line of weakness (40) in the outer case. Alternatively, the tape (20) can be perforated before application onto the outer case. The tape perforations (50) preferably penetrates the full thickness of the tape, but can alternatively penetrate only part of the thickness of the tape.

Any suitable means can be used to perforate the tape, the outer-case, and combinations thereof. Suitable means include using a laser, a knife, such as a rotary knife, punch-pins, and combinations thereof. Lasers are preferred. Suitable lasers include CO2 (Carbon Dioxide) lasers, preferably having a power output of from 5 W to 50 W, more preferably from 10 W to 30 W. Examples of suitable lasers include the SmartLase C150 (10 W), C150 S (10 W), the C350 (30 W), C350 L (30 W), C350S (30 W), supplied by Markem-Imaje, particularly for tapes which comprise polypropylene. Focused lasers, such as lasers comprising a lens to focus the beam, are particularly preferred. Such focused lasers deliver their maximum power over a short legth, that are capable of perforating the tape, outer case, and combinations thereof, with little or no damage to the articles contained within the outer case.

Grasping members (38) can be optionally employed to aid in the removal of the at least partially removable element (30). Preferably, the present invention employs at least one grasping member (38) on at least two faces of the at least partially removable element (30). More preferably, the removable element comprises a front face (32) and a top face (36), with both the front face (32) and the top face (36) comprising at least one grasping member (38), allowing separation of the removable element to start either from the front face (32) or the top face (36). Such grasping members are preferably positioned adjacent to the line of weakness (40). Thus, a person can engage the grasping members (38) and begin separation of the top face (36) of the at least partially removable element (30) from the shelf ready package (1). Preferably, the grasping member (38) remains attached to the at least partially removable element (30), when the at least partially removable element (30) is separated from the shelf ready package (1).

The grasping member (38) can be defined by secondary lines of weakness (39). Each secondary line of weakness (39) may exhibit a uniform resistance to separation along its entire length, or alternatively vary in resistance to separation along its length. Preferably, each secondary line of weakness (39) varies in resistance to separation along its length, allowing each grasping member (38) to be only partially disassociated from the walls (that is, separated along a first region and rotatably displaced along one or more remaining regions of secondary line of weakness (39). This avoids separate disposal issues. The secondary lines of weakness (39) can be perforated lines, with optionally each line having a varying resistance to separation along its length by virtue of having land components and perforation components of varying dimensions.

The grasping member (38) should be of sufficient size and geometry to readily receive at least one human finger, and preferably two fingers. Alternatively, various tools, such as a hook, could be inserted into the grasping member (38) for removing the at least partially removable element (30) from the shelf ready packaging (1).

The shelf ready packaging (1) preferably has a maximum box compression strength of at least 1500 N, preferably greater than 2500 N, more preferably greater than 3500 N, according to ISO 12048. The box compression strength of an outer-case, including shelf ready packages (1), is a direct measure of the stacking strength of outer-case. However, since the load-bearing properties of a box are often of decisive importance under modern transport conditions, it can also be said that the compression strength constitutes a general measure of the performance potential of an outer-case.

Both the properties of the materials of construction of the outer case and the properties of the line of weakness can affect the robustness of the shelf ready packaging (1), both before and after removal of the at least partially removable element (30). For instance, the maximum compression strength can be reduced because of the position and resilience of the line of weakness. This is a particular challenge where the line of weakness extends: over a corner, over the first upper portion (62) and the upper back portion (65), and combinations thereof. By closing the shelf ready package using tape (20), such that the tape is applied over at least part of the line of weakness (40) on the top face (6), or where the line of weakness (40) extends over a corner (see FIG. 1 for example), the overall compression strength of the shelf ready package (1) is improved, even when the at least partially removable element (30) has been removed.

When the tape (20) comprising tape perforations (50) overlaps the corner (as in FIGS. 1 and 2), the corner is reinforced, preventing the shelf ready package from collapsing at the corner, even when the line of weakness (40) extends over the corner.

When the tape (20) is perforated where the tape (20) and line of weakness (40) coincide, the line of weakness can extend over the first upper portion (62) and the upper back portion (65) of the carton blank (90) of the assembled outer case, without preventing the removal of the at least partially removable element (30) (see FIG. 6, for example).

A line of weakness (30) which passes through a vertical corner (for example, from side wall (3) to front wall (2), as in FIG. 1) can result in a loss in compression strength of the shelf ready package (1). Tape (20) comprising tape perforations (50) which coincides with the line of weakness (30) at the vertical corner, can be used to reinforce the vertical corner, and increase the compression strength of the shelf ready package (1).

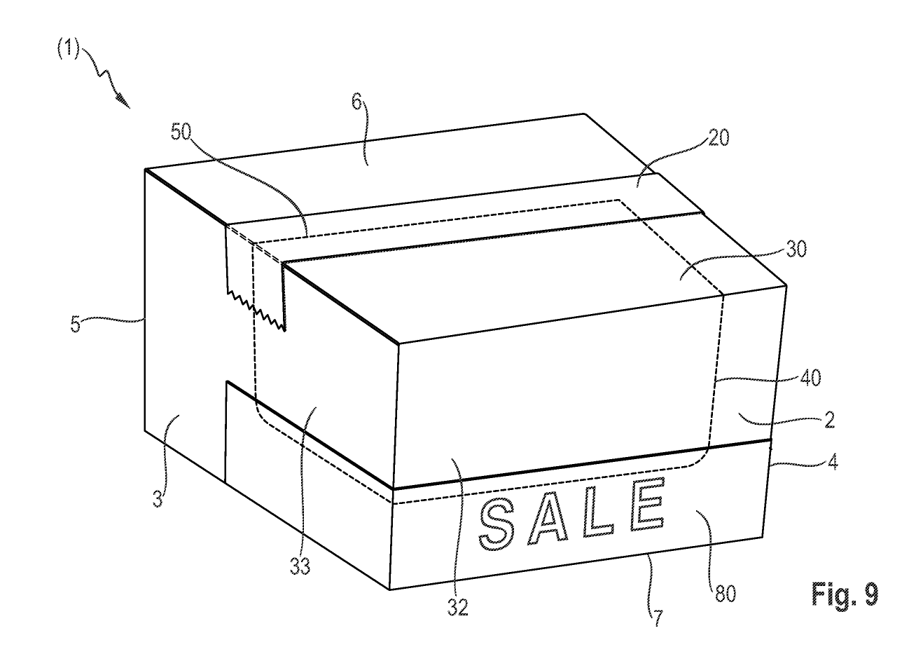

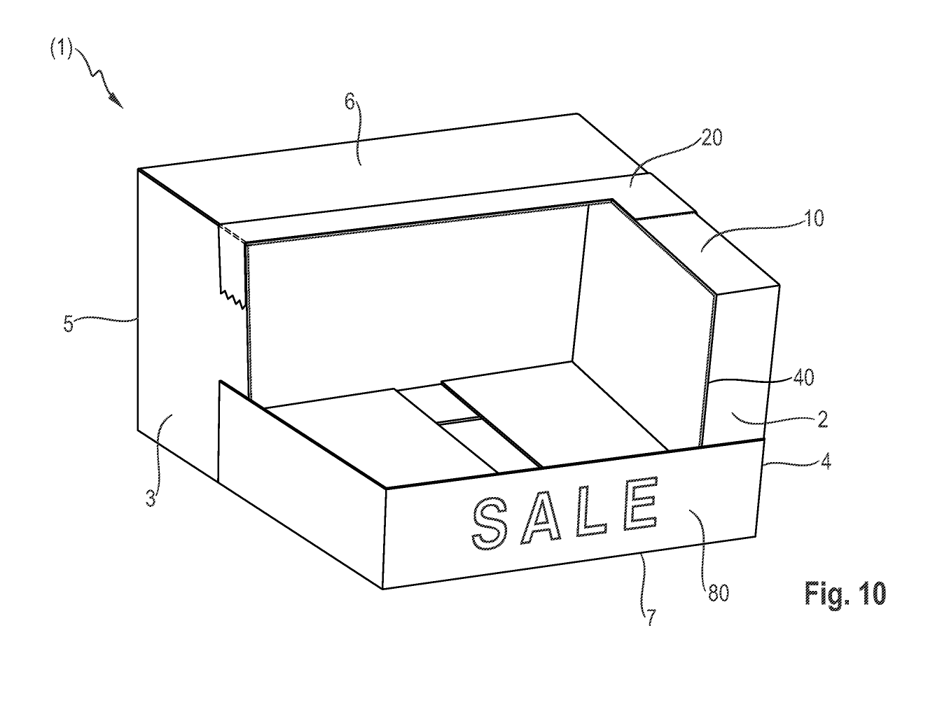

When the shelf ready package (1) comprises a line of weakness (30) which passes through at least one vertical corner, the shelf ready package (1) can further comprise a panel (80), such as a display panel, which covers the line of weakness (3) on the vertical corner (see FIG. 9 and FIG. 10). The compression strength of a shelf ready package (1), which comprises a line of weakness (30) which passes through a vertical corner between a side wall (3) or (4) and the front wall (2), can also be improved by adding a panel (80) which is attached to the side wall (3) or (4) and the front wall (2). The panel can be attached to the side wall (3) or (4) and the front wall (2) by any suitable means, including gluing, taping, and combinations thereof, though gluing is preferred. Such panels (80) can also be attached to the front wall (2) and both side walls (3) and (4). Where the panel (80) is continuous sleeve, having a front part, a back part, and two side parts, the panel (80) need not be attached to the shelf ready package (1), but can be slipped over the shelf ready package (1).

Such panels can also be used to advertise the product inside, or even to customise a generic shelf ready package (1) into one which displays information related to the articles contained therein.

The shelf ready package (1) can be formed using any suitable means. Such processes can include the steps of:
(a) folding a carton blank (60) to form an outer case having an at least partially removable element (30), formed by a line of weakness (40), such that the at least partially removable element (30) can be at least partially removed along the line of weakness (40);
(b) bonding the front lower portion (72) and back lower portion (75) together, preferably using glue, tape, and combinations thereof, to form a bottom wall (7);
(c) placing articles inside the outer case;
(d) bonding the first upper portion (62) and second upper portion (65) together using tape (20);
(e) perforating the tape to provide a tape (20) having tape perforations (50) which coincide with at least part of the line of weakness (30) of the outer case formed by the carton blank (60).

The carton blank (60) is typically made from paperboard, usually in roll-form. The paperboard is typically unwound for printing and the printed paperboard rerolled for later use, or immediately corrugated. Alternatively, printing can take place after corrugation.

Corrugation is typically achieved by running paperboard through corrugation wheels, to form a corrugated layer (often referred to as medium or fluting). A further two roll of paperboard is fed into the corrugators, either sequentially or simultaneously, and glued onto the corrugated layer to form the inner and outer layers of the single wall corrugated board. One or both of the inner and outer layers can be printed.

Alternatively, the corrugated board can have other structures, such as single face (one layer of liner and one layer of medium), double wall (3 layers of liners having 2 layers of mediums in between).

The corrugated board is typically cut into rectangular sheets (also called blanks), or can be directly cut into the required shape to form the carton blank (60). At the same time, or afterwards, the line of weakness (30) can be formed into the carton blank (60). The carton blank (60) is folded and glued to form the shelf ready package (1).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A shelf ready package (1) comprising at least one carton blank (60), formed into an outer case having:
(a) a top wall (6),
(b) two side walls (3) and (4),
(c) a front wall (2),
(d) a back wall (5),
the shelf ready package (1) further comprises an at least partially removable element (30), formed by a line of weakness (40), such that the at least partially removable element (30) can be at least partially or fully removed along the line of weakness (40),
wherein the shelf ready package (1) is at least partially sealed using tape (20) which overlaps with at least part of the line of weakness (40) in the outer case, and the tape (20) comprises tape perforations (50) which coincide with at least part of the line of weakness (30) of the outer case formed by the carton blank (60).

2. The shelf ready package (1) according to claim 1, wherein the tape perforations (50) are formed after the tape has been applied to the outer case, formed by the carton blank (60).

3. The shelf ready package (1) according to claim 1, wherein the tape perforations (50) are formed using a laser, a knife, punch-pins, and combinations thereof.

4. The shelf ready package (1) according to claim 3, wherein the tape perforations (50) are formed using a laser.

5. The shelf ready package (1) according to claim 1, wherein the line of weakness (40) in the outer case is formed by scoring; perforating; and combinations thereof.

6. The shelf ready package (1) according to claim 1, wherein the line of weakness extends: over a corner, over the first upper portion (62) and the upper back portion (65), and combinations thereof.

7. The shelf ready package (1) according to claim 1, wherein the line of weakness (40) is at least partially present on an upper portion selected from the group consisting of: the first upper portion (62), the second upper portion (65), or combinations thereof; and partially coincides with the tape perforations (50) on the tape (20) which connects the first upper portion (62) and the second upper portion (65).

8. The shelf ready package (1) according to claim 1, comprising a line of weakness (40) which passes through at least one vertical corner, the shelf ready package (1) further comprising a panel (80) which covers the line of weakness (40) on the vertical corner.

9. A pallet comprising at least two layers of the shelf ready package according to claim 1.

10. A process for making a shelf ready package (1) according to claim 1, comprising the steps of:
(a) folding a carton blank (60) to form an outer case having an at least partially removable element (30), formed by a line of weakness (40), such that the at least partially removable element (30) can be removed along the line of weakness (40);
(b) bonding the front lower portion (72) and back lower portion (75) together, preferably using glue, tape, and combinations thereof, to form a bottom wall (7);
(c) placing articles inside the outer case;
(d) bonding the first upper portion (62) and second upper portion (65) together using tape (20);
(e) perforating the tape (20) to provide a tape (20) having tape perforations (50) which coincide with at least part of the line of weakness (30) of the outer case formed by the carton blank (60).
